(19) United States
(12) Patent Application Publication
(10) Pub. No.: US 2004/0149066 A1
(43) Pub. Date: Aug. 5, 2004

(54) Tool-bearing carriage, in particular mobile in a pipe

(76) Inventor: Philippe Garrec, Gif-sur-Yvette (FR)

Correspondence Address: Pearne Gordon, McCoy & Granger, Suite 1200, 526 Superior Avenue East, Cleveland, OH, 44114-1484, US

(21) Appl. No.: 10/478,085

(22) PCT Filed: Jun. 4, 2002
(86) PCT No.: PCT/FR02/01874

(30) Foreign Application Priority Data
Jun. 6, 2001 (FR) 01/07367

(51) Int. Cl. B25J 17/00

(52) U.S. Cl. 74/490.04

(57) ABSTRACT

A movable carriage (5) in a main conduit (1) transporting a viewing tool (12) or a work tool (12) sends this tool into adjacent conduits (3) which connect to the previous one via a box and with a difference in level by deploying a semi-rigid and turning arm (10) longer than the radius of the main conduit.

The subject of this invention is a tool carriage, capable of being moved in a conduit so as to accomplish certain tasks in connection with the nature of the tool.

Some of these tasks can be accomplished in branch conduits, at the inlet of which the carriage stops so as to project the tool in a lateral direction: the tool is therefore fixed at the end of a flexible rod that can be moved forward via an appropriate mechanism and straightens up when in a free state; it therefore holds the tool, which it pushes to the required depth of the branch conduit. Such a carriage, however, becomes inoperative when the conduits are not convergent, meaning that the conduit in which the tool is to be pushed opens, with a difference in level, into the one where the carriage moves, which is often the case with conduits connected via a viewing hole: no system exists to date that allows access to such conduits.

The purpose of the invention is precisely to overcome this defect and to make it possible, for viewing or work tools carried by a carriage, to access sections of conduits which connect, with a difference of level, to a main conduit that is used by the carriage.

The carriage that satisfies this purpose is characterised in that it comprises a drum supported by the carriage, an arm supported by the drum and bearing, by means of a joint, a tool support, the arm being semi-rigid and having a free state of rigidity and a flexible state, and means of rotation of the drum around a longitudinal axis of the carriage, of deployment of the arm outwith the carriage, and of adjustment of the support around the joint.

These characteristics, as well as others, will become clearer upon reading the comments of the following figures:

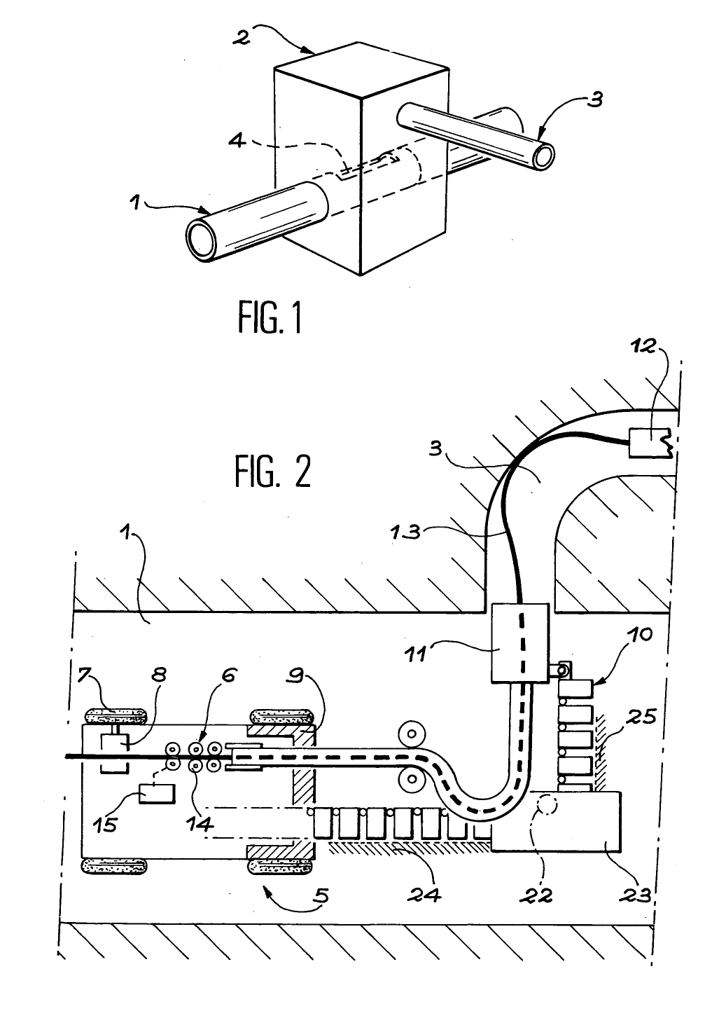

FIG. 1 illustrates a junction of conduits with a viewing hole;

FIG. 2 is an overall view of the carriage;

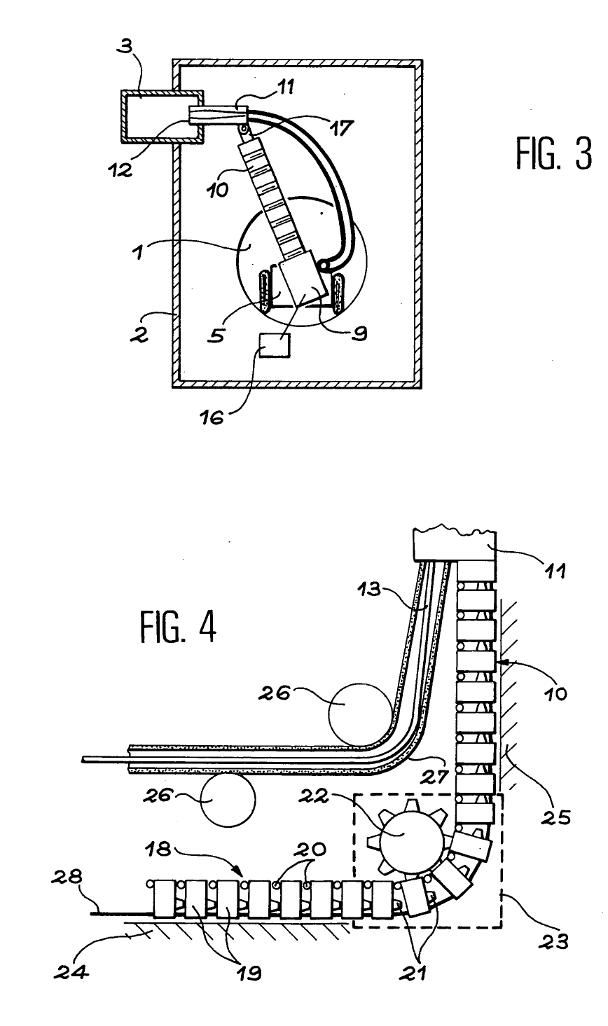

FIG. 3 is a longitudinal view of the carriage;

FIG. 4 illustrates the bending mechanism of the arm;

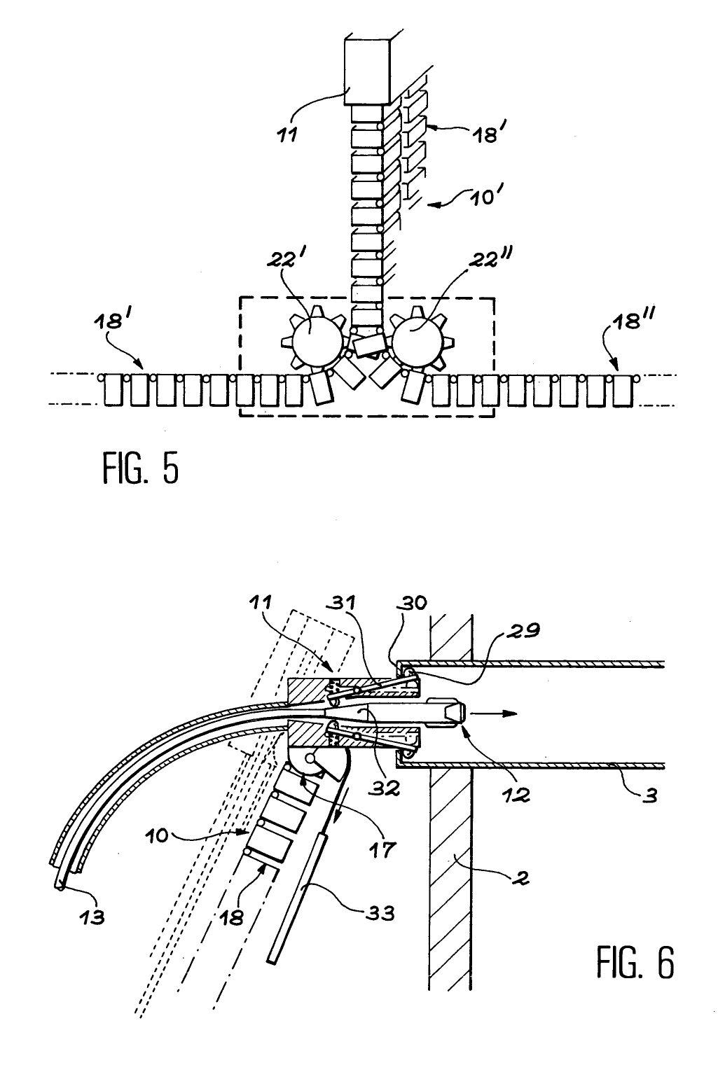

FIG. 5 illustrates a developed arm;

FIG. 6 represents the end of the arm;

FIG. 7 illustrates a train of carriages; and

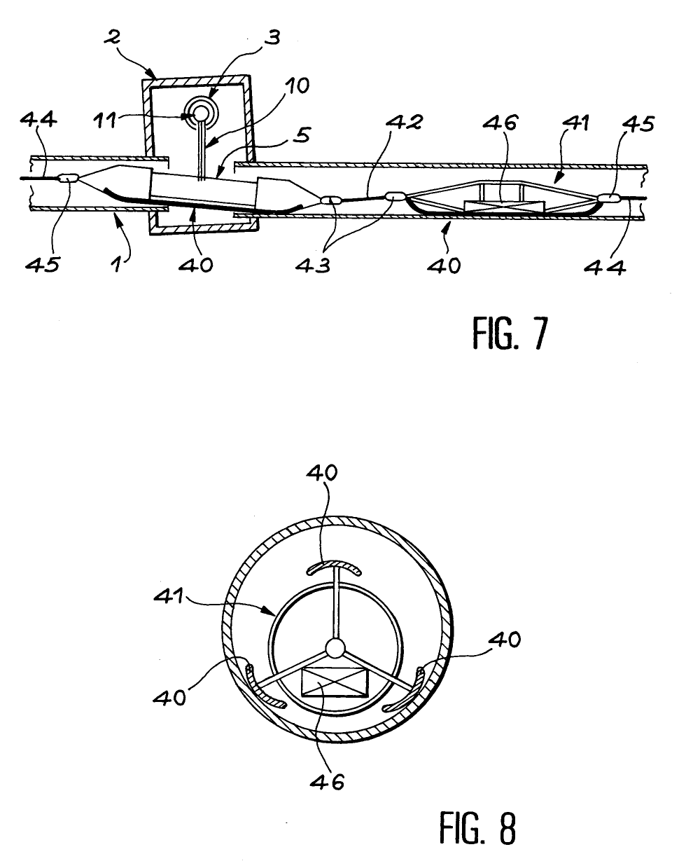

FIG. 8 is a cross-section of a carriage illustrated in FIG. 7.

FIG. 1 illustrates a connection of conduits where the invention can be deployed: a collector 1 is fitted with sumps 2 or connection boxes, one of which is represented and in which terminate the drains 3 of smaller diameter with a vertical difference in level. A carriage runs along the collector 1 and must project a tool that can be a viewing camera into the drain 3 through an opening 4 in the collector 1 in the sump 2. The carriage 5 comprises, as can be seen in FIG. 2, a body 6 fitted with loco-motor devices that can consist of rollers 7, some of which are driven by a motor 8 and, at the front, with a drum 9 turning around a longitudinal axis of the body 6. The drum 9 has an arm 10, better represented in other figures, whose end bears a tool support 11 in which the tool, in this case a camera 12, can be placed. As inspections of the drain 3 beyond its inlet are often necessary, it is advantageous that the camera 12 can be moved forward; it is therefore preferable to attach it to the end of a flexible rod 13 which passes through the carriage 5 towards the exterior of the collector 1, where its end is wound up via a winch that is not represented; rollers 14 mounted to the body 6 of the carriage 5 can be moved via another motor 15 allowing it to be pulled so as to move the camera 12 forward enabling it to enter the drain 3. The flexible rod has the properties of straightening up as soon as it is free and thus supports the camera 12 perfectly whilst maintaining the necessary flexibility to pass through the bends in the drain 3.

FIG. 3 shows that the arm 10 must be deployed in a radial manner in relation to the axis of the collector 1 and of the carriage 5, so as to protrude from the opening 4, and it must also be pivotal in an angular manner so as to approach the inlet of the drain 3; a motor 16 capable of turning the drum 9 fulfils this last requirement. Finally, the support 11 must be turned to face the inlet of the drain 3. To do this, it is connected to the end of the arm 10 via a joint 17.

FIG. 4 shows that the arm 10 can be comprised of a length of a chain 18; this chain is of a particular nature even though it is of a known sort, and is more precisely semi-rigid, meaning that it has at the same time a free state, characteristic of the arm 10, where it is rigid and another state where it is flexible. This characteristic allows it to be bent and for its length to be placed behind the arm 10 in the axial direction of the collector 1, in which it can thus be moved with ease. The chain 18 can be comprised of chain links 19 connected to each other via pins 20 located on one side but which are fitted with abutments 21 which restrict their rotational movement around the pins 20 and thus provide the chain 18 with single-sided rigidity. The device also comprises a drive sprocket 22, mounted onto the body 6 of the carriage 5 and driven by a motor 23, a longitudinal slideway 24 at the back of the chain 18 and a radial slideway 25 in front of the sprocket 22. These slideways 24 and 25 are, as for the sprocket 22 and its motor 23, mounted onto the drum 9 and set the direction of the chain 18 in front of and behind the sprocket 22, as well as a right angle deflection. When the sprocket 22 is put into motion it moves the chain 18 forwards or backwards and adjusts the free length of the arm 10. This structure has the inconvenience of not being totally stable because the rigidity of the chain is single-sided. A solution consists in balancing it via the driving of the rod 13 if it is favourably placed, meaning subject to a bending stress which aims at straightening it so as to place the chain links 19 in abutment. Capstan guides 26 can subject the rod 13 to a curvature 27 in the same direction as that of the chain 18 next to the sprocket 22 to carry out this function. The chain links 19 can also be connected together via an elastic cable 28 running on the opposite side of the pins 20 and taut so as to bring all the free sections of the arm 10 into a rectilinear state. Finally, another solution consists in combining two chains 18′ and 18″ similar to the chain 18 but placed symmetrically and driven by the respectively adjacent sprockets 22′ and 22″: the prior lengths of the chains 18′ and 18″ are juxtaposed to form a composite arm 10′ and their subsequent lengths lie in opposite directions and substantially in extension. The assembly of chains 18′ and 18″ therefore has a two-sided rigidity without any additional means.

The tool support 11 is described in FIG. 6. Its orientation can thus be ensured via a cable 33 attached to the support 11 with an overhang so as to turn it around the joint 17. The appropriate angle of rotation to bring the camera 12 parallel to the drain 3 is known according to the slant of the arm 10, as the rod 13 aims at applying a restoring moment towards an invariable abutment position, where the camera 12 is orientated in the extension of the arm 10, as indicated by the doted line position. The cable 33, which passes through the body 6 of the carriage 5 and extends as far as the exterior, is strained to inhibit this spring restoring action and to turn the tool support 11 to the required angle.

The tool support 11 can comprise clamps 29 gripping onto a surrounding structure such as the inlet 30 of the drain 3 upon opening, which can be achieved by the tilting of axes 31 which bear these clamps 29 via the deploying of springs. When the camera 12 is placed in the tool support 11, a taper shank 32, with which it is endowed, penetrates into a housing of complementary shape of the tool support 11 and forces the clamps 29 to close in by pushing on their axes 31 against the force of the springs. With this system of gripping, the entire carriage 5 is firmly held in place whilst the camera 12 accomplishes its task in the drain 3.

Among the possible equivalents of semi-rigid chains, it is to be noted that tubes exist of particular section, oblong with two symmetric outlines, substantially elliptic in the direction of a small axis but coming together via substantially parallel lips creating an acute angle in the direction of a large axis. Such tubes are at the same time sufficiently flexible and elastic to be crushed between the rollers whilst maintaining the possibility of straightening up in the free state. They are characterised by high rigidity in the free state and by practically complete flexibility when they are crushed, thus allowing them to be deformed at will and notably to wind them up using a winch.

The stabilising of the carriage 5 against tilting which could be caused by the lateral overhang of the arm 10 can be compensated for by counterweight held either at the bottom of the carriage 5 or in another carriage, which could be added to carriage 5 and coupled to the latter via a rigid torsion linkage, comprised of a bar connected at its ends to two carriages via universal joints. More generally, the carriage 5 could be incorporated to an articulated train of carriages, which are often used for this type of work.

Another requirement that may need to be satisfied is the crossing of sections of the collector 1 when they are separated by large openings at their points of connection, which could be the case in the sump 2. Elongated shoes are thus used, in the shape of skis, under the carriage 5 and which lean on the two sections of the collector 1 when the carriage 5 crosses over the points of connection. A sufficient number of loco-motor devices (the motorised rollers 7) also need to be supplied so that the carriage 5 continues to be pulled when some of them cross over the points of connection. If the carriage 5 belongs to a train, several elements of the latter can be motors.

This design is represented in FIGS. 7 and 8 where the main carriage 5 (carrier of the tool 12 and of its support 11) is fitted with skis 40, the same as for an auxiliary carriage 41. The carriages 5 and 41 are linked via a rigid bar 42 fitted with universal joints 43 at their ends, thus allowing differences in levels and changes in direction from one carriage to another. Other rigid bars 44 with universal joints 45 can extend this train of carriages by coupling them to other elements, not represented. The auxiliary carriage 41 carries the counterweight 46. FIG. 8 shows that there are three skis 40 regularly spaced out so as to avoid an excessive off-centring of the carriages 5 and 41 in all possible directions; otherwise two lateral lower skis suffice. The positioning of the skis 40 can be the same for all of the carriages.

Finally, the tool can be a work or intervention tool such as a viewing tool: its nature is immaterial to the invention.

1. Tool carriage, characterised in that it comprises a drum (9) supported by the carriage (5), an arm (10) supported by the drum (9) and bearing by means of a joint (17) a support (11) for the tool (12), the arm (10) being semi-rigid and having a free state of rigidity and a flexible state, and means of rotation (16) of the drum (9) around a longitudinal axis of the carriage, of deployment (22, 23) of the arm outwith the carriage and in a lateral direction of the carriage, and of adjustment (33) of the support (11) around the joint.

2. Tool carriage according to claim 1, where a flexible rod (13) is linked to the tool (12), characterised in that the support (11) for the tool has a conical cavity into which a complementary shape (32) of the tool (12) can be placed, and the carriage comprises a driving force of the rod.

3. Tool carriage according to claim 2, characterised in that the tool support comprises clamps (29) for gripping onto a surrounding structure (30).

4. Tool carriage according to claim 3, characterised in that it comprises a clamps deployment spring, inhibited by the tool as long as the latter is in the support.

5. Tool carriage according to any one of claims 1 to 4, characterised in that the arm comprises a chain (18, 18′) of single-sided rigidity.

6. Tool carriage according to claim 5, characterised in that the arm comprises a second chain (18″) of single-sided rigidity, the chains being juxtaposed in the free state so as to constitute an assembly of two-sided rigidity.
